(19) United States
(12) Patent Application Publication
(10) Pub. No.: US 2021/0191375 A1
(43) Pub. Date: Jun. 24, 2021

(54) METHOD FOR CARRYING OUT MEASUREMENTS ON A VIRTUAL BASIS, DEVICE, AND COMPUTER READABLE MEDIUM

(71) Applicant: HONGFUJIN PRECISION ELECTRONICS (TIANJIN) CO., LTD., Tianjin (CN)

(72) Inventors: HSUEH-FANG AI, New Taipei (TW); CHUN-HUNG LEE, Neihu (TW); SHANG-YI LIN, New Taipei (TW)

(21) Appl. No.: 16/850,222

(22) Filed: Apr. 16, 2020

(30) Foreign Application Priority Data
Dec. 18, 2019 (CN) 201911306370.7

(51) Int. Cl. G05B 19/418; G06N 3/08

(52) U.S. Cl. CPC G05B 19/41885; G05B 19/4188; G05B 2219/45031; G06N 3/08; G05B 19/4183

(57) ABSTRACT

A method for carrying out measurements on a virtual basis to decrease the frequency of taking and analyzing actual physical samples and interruptions caused thereby includes obtaining production information of at least one production device; and generating prediction data of measured products and unmeasured products using the production information and a prediction model, the prediction data comprising critical dimension data of the product. A virtual metrology device and a computer readable storage medium are also provided.

### FIELD

The disclosure generally relates to a virtual metrology method, and a virtual metrology device.

### BACKGROUND

In manufacturing semiconductor or panel production, critical dimension data such as the thickness of a film or width of an electrical line needs to be obtained in real time to ensure the correctness of the process. In the early days, the metrology was done by sampling. As the manufacturing process became more complicated year by year, and the need for accuracy increased sharply, the frequency of sampling needed to be increased. However, the cost of the metrology machine is high, and automatic construction requires space, huge expenditure, and non-interruption in the manufacturing process. Therefore, the existing metrology methods are costly in several ways.

### BRIEF DESCRIPTION OF THE DRAWINGS

Implementations of the present technology will now be described, by way of embodiments, with reference to the attached figures.

FIG. 1 is a schematic diagram illustrating an embodiment of an operating environment of a virtual metrology device.

FIG. 2 is a block diagram illustrating an embodiment of the virtual metrology device.

FIG. 3 is a block diagram illustrating an embodiment of a virtual metrology system.

FIG. 4 is a flowchart illustrating a method for metrology by virtual means in one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

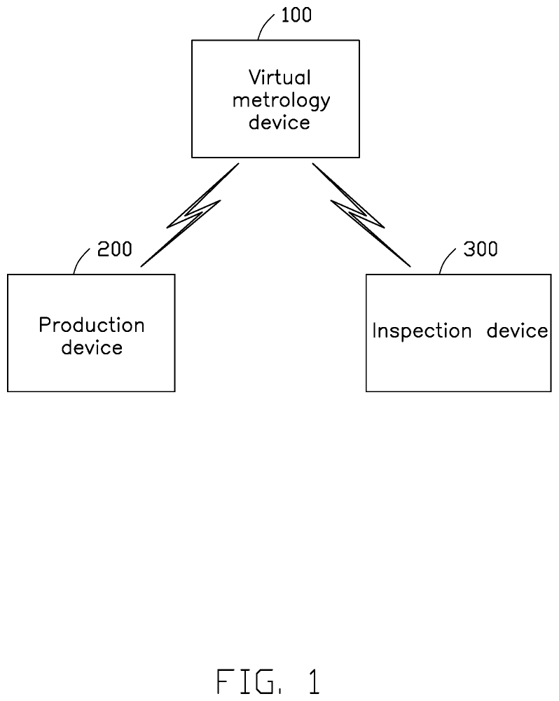

FIG. 1 illustrates an embodiment of an environment of a virtual metrology device. The virtual metrology device 100 can be in communication with at least one production device 200, and at least one inspection device 300.

The production device 200 may be used in the process of making a semiconductor or panel. For example, the production device 200 may be a set of production machines in a yellow-light photolithography process, including, but not limited to, a pre-cleaning machine, a photoresist coating machine, a pre-baking machine, an exposure machine, a developing machine, and a post-baking machine. The production device 200 can also be other devices, such as a film coating machine, or a solder paste printing machine.

The inspection device 300 is used for inspecting the products to obtain metrology data including various critical dimensions of the products. The critical dimensions can include a line width and a film thickness. The critical dimensions can be set according to the actual requirements. For example, the critical dimensions may also include length, width, height, and relative angle of the entire or part of the product.

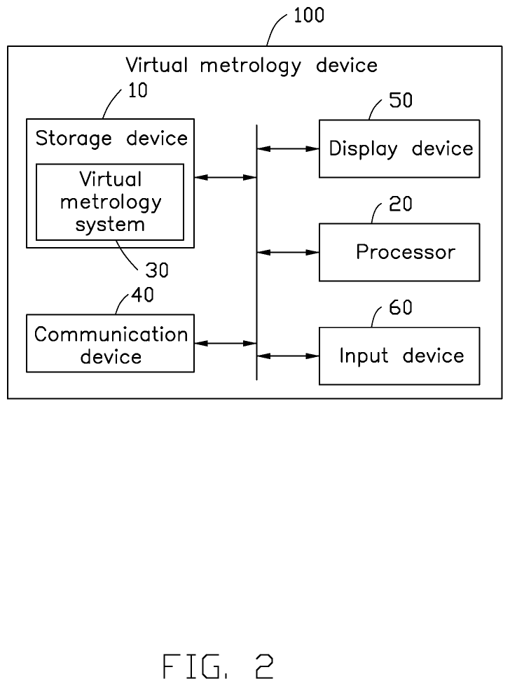

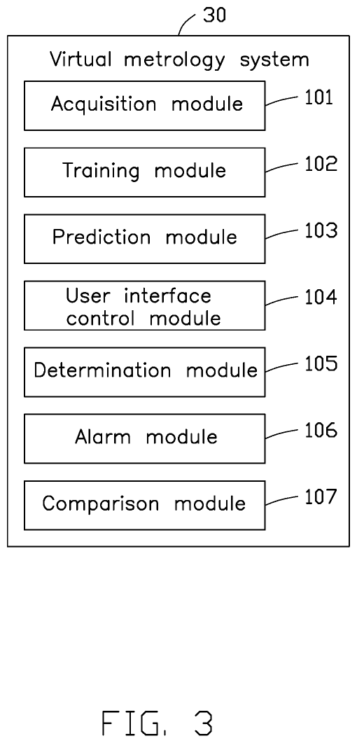

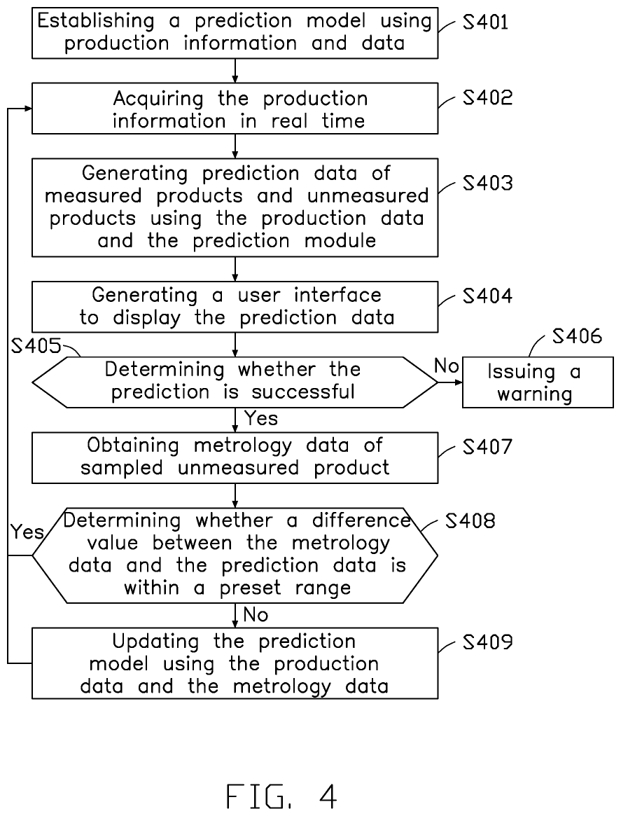

FIG. 2 illustrates an embodiment of the virtual metrology device 100. The virtual metrology device 100 can include a storage device 10, a processor 20, and a virtual metrology system 30 stored in the storage device 10 and executable on the processor 20. When the processor 20 executes the virtual metrology system 30, the steps in the embodiment of the virtual metrology method are implemented, for example, steps in block 5401 to 5409 shown in FIG. 4. Alternatively, when the processor 20 executes the virtual metrology system 30, the functions of the modules in the embodiment of the virtual metrology system are implemented, for example, modules 101 to 107 as in FIG. 3.

The processor 20 may include one or more central processor units (CPUs), or the processor 20 may be another general purpose processor, a digital signal processor (DSP), an application-specific integrated circuit (ASIC), a field programmable gate array (FPGA), or another programmable logic device, discrete gate or transistor logic device, discrete hardware component, or the like. The general purpose processor may be a microprocessor, or the processor may be any conventional processor or the like. The processor 20 may use various interfaces and communication buses to connect various parts of the virtual metrology device 100.

The storage device 10 stores various types of data in the virtual metrology device 30, such as program codes and the like. The storage device 10 can be, but is not limited to, read-only memory (ROM), random-access memory (RAM), programmable read-only memory (PROM), erasable programmable ROM (EPROM), one-time programmable read-only memory (OTPROM), electrically EPROM (EEPROM), compact disc read-only memory (CD-ROM), smart media card (SMC), secure digital (SD) card, flash card, hard disk, solid-state drive, or other forms of electronic, electromagnetic, or optical recording medium.

In one embodiment, the virtual metrology device 100 may further include a communicating device 40, a display device 50, and an input device 60. The communicating device 40, the display device 50, and the input device 60 are electrically connected to the processor 20.

The communicating device 40 can communicate with the production device 200 and the inspection device 300 wirelessly or by wires.

The display device 50 can display the results of operations by the processor 20. The display device 50 can include a display screen or a touch screen.

The input device 60 can be used to input various information or instructions. The input device 60 can include a keyboard, a mouse, a touch screen.

The virtual metrology device 100 may include more or fewer components than those illustrated, or combine some components, or be otherwise different. For example, the virtual metrology device 100 may also include network access devices, buses, and the like.

FIG. 3 shows the virtual metrology system 30 running in the virtual metrology device 100. The virtual metrology system 30 may include an acquisition module 101, a training module 102, a prediction module 103, a user interface control module 104, a determination module 105, an alarm module 106, and a comparison module 107. In one embodiment, the above module may be a programmable software instruction stored in the storage device 10, callable by the processor 20 for execution. It can be understood that, in other embodiments, the above modules may also be program instructions or firmware fixed in the processor 20.

The acquisition module 101 acquires production information and metrology data.

In one embodiment, the acquisition module 101 acquires the production information sent by the production device 200 and the metrology data sent by the inspection device 300.

The production information includes the production parameters of the production device 200. Taking the machine of the yellow-light photolithography process as an example, the production parameters include numerical parameters and nominal parameters. The numerical parameters include temperature, time, voltage, current, and rotation speed related to photoresist, and the nominal parameters include the coding of the tray or the like.

The metrology data includes the critical dimension data of the products produced by the production device 200. The critical dimension data includes the line width and film thickness. The critical dimension data may further include other dimension data, such as a length or a width of a whole or part of a structure of the product, size, angle, and other data.

In at least one embodiment, the acquisition module 101 further acquires an instruction to update the prediction model.

The training module 102 establishes and updates a prediction model according to production information and metrology data. The prediction model may be a statistical model or a machine learning model.

The prediction module 103 generates predictive data of the measured products and the unmeasured products through the prediction model according to the real-time production information, and the prediction data includes the critical dimension data.

The user interface control module 104 generates a user interface for display.

In one embodiment, the user interface control module 104 generates a user interface to display the prediction data.

In one embodiment, the user interface control module 104 further generates a user interface to display a difference value between the measured data and the prediction data, and a preset range of the difference.

The determination module 105 determines whether a difference value between the metrology data and the prediction data is within a preset range.

The determination module 105 further determines whether the prediction data is successfully generated.

The alarm module 106 issues a warning when the prediction fails.

The comparison module 107 compares the metrology data of the same product by multiple inspection devices 300 to correct the metrology data.

A virtual metrology method is illustrated in FIG. 4. The method is provided by way of embodiments, as there are a variety of ways to carry out the method. Each block shown in FIG. 4 represents one or more processes, methods, or subroutines carried out in the example method. Additionally, the illustrated order of blocks is by example only and the order of the blocks can be changed. The method can begin at block S401.

At block S401, a prediction model is established using the production information and the metrology data.

In one embodiment, the process at block S401 includes obtaining the production information of the production device 200 and the metrology data of the products produced by the production device 200, and establishing the prediction model using the production information and the metrology data.

The production information and the metrology data may be stored in a database. The database includes sample data, and data as to each sample includes the production information of the production device 200 and metrology data of a corresponding product.

The production information includes the production parameters of the production device 200. Taking the machine of the yellow-light photolithography process as an example, the production parameters include numerical parameters and nominal parameters. The numerical parameters include temperature, time, voltage, current, and rotation speed related to photoresist, and the nominal parameters include the coding of the tray or the like. The metrology data includes a line width and a film thickness.

For another example, when the production device 200 is a coating machine, its production information may include a distance between a target and a substrate, a concentration of coating gas, coating time, target sputtering speed, and gear rotation speed. The metrology data may include film thickness and line width.

When the production device 200 is a solder paste printing machine, its production data may include parameters such as blade pressure, printing speed, demolding speed, and demolding distance. The metrology data may include solder paste height, solder paste area, and solder paste volume.

In one embodiment, a process of obtaining the production information and metrology data of the measured products includes receiving the production information from at least one production device and the metrology data from at least one inspection device; extracting, converting, and loading the production information and the metrology data; and storing the production information and the metrology data in the database.

The prediction model may be a statistical model or a machine learning model, such as a CNN or RNN neural network model. After establishing the prediction model, test sample data is input into the prediction model for testing. When test results meet preset requirements, the prediction model can be applied to virtual metrology. It can be understood that after the prediction model is established, as the sample data continue to increase, the prediction model may be updated with new sample data. In establishing the prediction model, domain knowledge or analyst experience can be added.

In one embodiment, a prediction model may be established for different sets of production devices 200, different metrology targets, and different metrology points, and then the predicted values of one product are aggregated according to the cut products.

At block S402, the production information in real time is acquired.

The production information may be sent by at least one production device 200.

At block S403, predictive data of measured products and unmeasured products is generated using the production data and the prediction module.

The prediction data of the unmeasured products are predicted through the prediction model, and the prediction data of the measured products are adapted through the prediction model. The prediction data includes the critical dimension data of the products, and whether or not a product will be passed can be predicted through the prediction data.

At block S404, a user interface to display the prediction data is generated.

The display device can display the prediction data, for reference by an engineer.

At block S405, a determination is made as to whether the prediction is successful.

If the prediction is successful, the process proceeds to block S407. If the prediction is unsuccessful, the process proceeds to block S406.

At block S406, a warning is generated.

When the production data is not obtained or the prediction data is not successfully calculated, it is determined that the prediction is failed, and the warning is generated and sent to a Computer Integrated Manufacturing (CIM) engineer, or to a manufacturing execution system (MES), so that engineers can handle such exceptions in a timely manner. The display device may also issue an alert.

At block S407, metrology data of sampled unmeasured product is obtained.

In order to avoid misprediction causing losses to subsequent production, sampled unmeasured product can be detected in the sampling procedure. The process at block S407 may be omitted, and it can be determined according to the production conditions of the factory, such as required production speed or the precision requirement of the product.

At block S408, a determination is made as to whether a difference value between the metrology data and the prediction data is within a preset range.

The preset range is a range of allowable error and can be set according to requirements. If it is determined that the difference between the metrology data and the prediction data exceeds the preset range, the process proceeds to block S409; if it is determined that the difference between the metrology data and the prediction data is within the range, the prediction model can continue to be used, and returns to block S402.

At block S409, the prediction model is updated using the production data and the metrology data.

When updating the prediction model, the original prediction model may be deleted and a new prediction model may be constructed based on the original and newly acquired production information and metrology data in the analysis database, or the original prediction model may be adjusted. For example, updating the coefficients or the number of hidden layers by newly acquired production information and metrology data in the analysis database continuously or when the differences between prediction and measurement are greater than the threshold After the prediction model is updated, the process returns to block S402.

In one embodiment, the process at block S409 includes the following steps.

Firstly, a user interface displays the preset range, and the difference value between the metrology data and the prediction data is generated.

Secondly, an instruction to update the prediction model is received.

Thirdly, the prediction model is reconstructed or adjusted using the production information and the metrology data.

In other embodiments, the process at block S401 may be omitted, and the virtual metrology can be implemented by using the established prediction model.

In other embodiments, the processes at blocks S404 to S408 may be omitted.

In other embodiments, the method may further include the step of comparing the metrology data of the same product of a plurality of the inspection devices 300 at predetermined intervals to correct the metrology data.

It can be understood that for the same product and the same film layer, multiple metrology data can be obtained after metrology by multiple inspection devices 300, and a comparison of multiple metrology data can be used by personnel in the factory to correct the inspection device 300.

The virtual metrology method, device, and computer readable storage medium can acquire production information of at least one production device, and generate prediction data of measured products and unmeasured products using the production information and the prediction model. The above-mentioned virtual metrology device 100, method, and computer readable storage medium can realize virtual metrology in industrial production, and improve metrology quality with less cost.

The virtual metrology method, device, and computer readable storage medium can further determine whether a difference value between the metrology data and the prediction data is within a preset range; and update the prediction model using the production information and the metrology data when the difference value is not within the preset range. Therefore, the frequency of taking samples can be decreased, and detection costs can be saved. The prediction data can be monitored to avoid the impact of wrong predictions on subsequent production, and the accuracy and reliability of virtual metrology are improved.

A person skilled in the art can understand that all or part of the processes in the above embodiments can be implemented by a computer program to instruct related hardware, and that the program can be stored in a computer readable storage medium. When the program is executed, a flow of steps of the methods as described above may be included.

In addition, each functional device in each embodiment may be integrated into one processor, or each device may exist physically separately, or two or more devices may be integrated into one device. The above integrated device can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A virtual metrology method, comprising:
acquiring production information of at least one production device; and
generating predictive data of measured products and unmeasured products using the production information and a prediction model, the predictive data comprising critical dimension data of the product.

2. The virtual metrology method of claim 1, further comprising:
obtaining metrology data of sampled unmeasured product;
determining whether a difference value between the metrology data and the predictive data is within a preset range; and
updating the prediction model using the production information and the metrology data when the difference value is not within the preset range.

3. The virtual metrology method of claim 2, wherein a process of updating the predict module comprises:
generating a user interface to display the preset range, and the difference value between the metrology data and the predictive data;
receiving an instruction to update the prediction model; and
reconstructing or adjusting the prediction model using the production information and the metrology data.

4. The virtual metrology method of claim 1, further comprising:
determining whether the prediction is successful; and
issuing a warning, if the prediction is not successful.

5. The virtual metrology method of claim 1, further comprising:
obtaining the production information and metrology data of the measured products; and
establishing the prediction model using the production information and the metrology data, the prediction model being a statistical model or a machine learning model.

6. The virtual metrology method of claim 5, wherein a process of obtaining the production information and metrology data of the measured products, comprises:
receiving the production information from at least one production device and the metrology data from at least one inspection device;
extracting, converting, and loading the production information and the metrology data; and
storing the production information and the metrology data in a database.

7. The virtual metrology method of claim 6, wherein the method further comprising:
comparing the metrology data of the same product from a plurality of the metrology devices at predetermined intervals, to correct the metrology data.

8. The virtual metrology method of claim 1, wherein the critical dimension data comprises thickness of a film and width of a metal line.

9. A virtual metrology device, comprising:
at least one processor;
at least one storage device storing one or more programs, when executed by the processor, the one or more programs cause the processor to:
acquire production information of at least one production device;
generate predictive data of measured products and unmeasured products using the production information and a prediction model, the predictive data comprising critical dimension data of the product.

10. The virtual metrology device of claim 9, wherein the one or more programs cause the processor to:
obtain metrology data of sampled unmeasured product;
determine whether a difference value between the metrology data and the predictive data is within a preset range;
update the prediction model using the production information and the metrology data when the difference value is not within the preset range.

11. The virtual metrology device of claim 10, wherein a process of updating the predict module comprises:
generating a user interface to display the preset range, and the difference value between the metrology data and the predictive data;
receiving an instruction to update the prediction model; and
reconstructing or adjusting the prediction model using the production information and the metrology data.

12. The virtual metrology device of claim 9, wherein the one or more programs further cause the processor to:
determine whether the prediction is successful; and
issue a warning, if the prediction is not successful.

13. The virtual metrology device of claim 9, wherein the one or more programs further cause the processor to:
obtain the production information and metrology data of the measured products; and
establish the prediction model using the production information and the metrology data, the prediction model being a statistical model or a machine learning model.

14. The virtual metrology device of claim 13, wherein a process of obtaining the production information and metrology data of the measured products, comprises:
receiving the production information from at least one production device and the metrology data from at least one inspection device;
extracting, converting, and loading the production information and the metrology data;
storing the production information and the metrology data in an analysis database.

15. The virtual metrology device of claim 9, wherein the one or more programs further cause the processor to:
compare the metrology data of the same product from a plurality of the metrology devices at predetermined intervals, to correct the metrology data.

16. The virtual metrology device of claim 9, wherein the critical dimension data comprises thickness of a film and width of a metal line.

17. A computer readable storage medium having stored thereon instructions that, when executed by at least one processor of a computing device, causes the processor to perform a virtual metrology method , wherein the method comprises:
acquiring production information of at least one production device;
generating predictive data of measured products and unmeasured products using the production information and a prediction model, the predictive data comprising critical dimension data of the product.

18. The computer readable storage medium of claim 17, wherein the method further comprising:
obtaining metrology data of sampled unmeasured product;
determining whether a difference value between the metrology data and the predictive data is within a preset range;
updating the prediction model using the production information and the metrology data when the difference value is not within the preset range.

19. The computer readable storage medium of claim 18, wherein a process of updating the predict module comprises:
generating a user interface to display the preset range, and the difference value between the metrology data and the predictive data;
receiving an instruction to update the prediction model;
reconstructing or adjusting the prediction model using the production information and the metrology data.

20. The computer readable storage medium of claim 17, wherein the method further comprising:
determining whether the prediction is successful;
issuing a warning, if the prediction is not successful.
